(19) United States
(12) Patent Application Publication
(10) Pub. No.: US 2023/0206301 A1
(43) Pub. Date: Jun. 29, 2023

(54) MEMBER REGISTRATION SYSTEM, MEMBER REGISTRATION METHOD, AND INFORMATION STORAGE MEDIUM

(71) Applicant: Rakuten Group, Inc., Tokyo (JP)

(72) Inventors: Shizuka ENDO, Tokyo (JP); Tatsuko OKUNO, Tokyo (JP); Mariko OGURA, Tokyo (JP); Tomohiro SHIMONO, Tokyo (JP); Junpei HIRAKAWA, Tokyo (JP); Hideaki YOSHIURA, Tokyo (JP); Taichi WATANABE, Tokyo (JP)

(73) Assignee: Rakuten Group, Inc., Tokyo (JP)

(21) Appl. No.: 18/068,225

(22) Filed: Dec. 19, 2022

(30) Foreign Application Priority Data
Dec. 28, 2021 (JP) 2021-214579

(51) Int. Cl. G06Q 30/0601; G06Q 10/02

(52) U.S. Cl. CPC G06Q 30/0631; G06Q 10/02

(57) ABSTRACT

Provided is a member registration system which is configured to: receive a start request issued by a user in a first service to start member registration of a second service; display, when the start request is received, fields for the member registration on one page in the first service; and request, based on input to the one page from the user, a second service server associated with the second service to execute the member registration.

### CROSS-REFERENCE TO RELATED APPLICATION

The present application claims priority from Japanese application JP 2021-214579 filed on Dec. 28, 2021, the content of which is hereby incorporated by reference into the application.

### BACKGROUND OF THE INVENTION

### 1. Field of the Invention

The present disclosure relates to a member registration system, a member registration method, and an information storage medium.

### 2. Description of the Related Art

There has heretofore been known a technology for prompting a user of a first service to register as a member of a second service. In many cases, the user is required to access the first service again after accessing the second service and completing new-member registration, and report the completion of registration as a new member of the second service to the first service by some means, which is a hassle to the user. In JP 2006-350809 A, for example, there is described a possible solution that is a technology involving display of a first page for selecting a reward point service to register as a member after a user of a financial service starts member registration to reward point services, and provision of member information of the financial service to the reward point service selected on the first page. With the technology as described in JP 2006-350809 A, a second page for inputting additional information is displayed when a reward point service requiring additional information is selected, and member registration to the reward point service is completed based on the additional information input on the second page.

### SUMMARY OF THE INVENTION

However, with the technology as described in JP 2006-350809 A, the financial service is required to check whether the additional information is required after transmitting a new-member registration request including basic information of the user to the reward point service and, when the additional information is required, transmit, to the user, the second page for inputting additional information which is set so as to be transmitted directly to the reward point service. Consequently, when the financial service is to execute member registration to a reward point service, a heavy processing load is applied to the financial service. This is true also for a case in which the first service other than a financial service handles member registration to the second service other than a reward point service. The technology of the related art thus causes a hassle for a user when the user accesses the second service, and causes a processing load on the first service when the first service is to handle member registration to the second service.

The present disclosure has an object to reduce both of a hassle for a user when a user executes member registration to a second service and a processing load on a first service.

According to at least one embodiment of the present disclosure, there is provided a member registration system which is configured to: receive a start request issued by a user in a first service to start member registration of a second service; display, when the start request is received, fields for the member registration on one page in the first service; and request, based on input to the one page from the user, a second service server associated with the second service to execute the member registration.

### BRIEF DESCRIPTION OF THE DRAWINGS

FIG. 1 is a diagram for illustrating an example of an overall configuration of a member registration system.

FIG. 2 is a diagram for illustrating an example of shifts between pages in a case in which a user uses an integrated reservation service.

FIG. 3 is a diagram for illustrating the example of shifts between pages in the case in which the user uses the integrated reservation service.

FIG. 4 is a function block diagram for illustrating an example of functions in at least one embodiment of the present disclosure.

FIG. 5 is a table for showing an example of a first user database.

FIG. 6 is a table for showing an example of a hotel database.

FIG. 7 is a table for showing an example of a second user database.

FIG. 8 is a flow chart for illustrating an example of processing in the at least one embodiment.

FIG. 9 is a flow chart for illustrating the example of the processing in the at least one embodiment.

FIG. 10 is a function block diagram in a modification example.

### DESCRIPTION OF THE EMBODIMENTS

### 1. Overall Configuration of Member Registration System

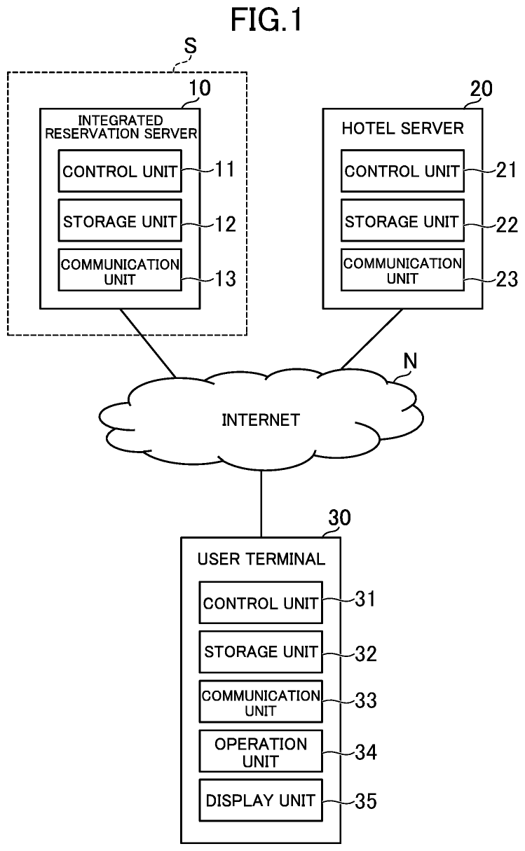

An example of a member registration system according to at least one embodiment of the present disclosure is described. FIG. 1 is a diagram for illustrating an example of an overall configuration of the member registration system. A member registration system S includes an integrated reservation server 10 connectable to Internet N. The integrated reservation server 10 can hold communication to and from a hotel server 20 and a user terminal 30 via the Internet N. The member registration system S is only required to include at least one computer, and is not limited to the example of FIG. 1. For instance, the member registration system S may include a plurality of server computers.

The integrated reservation server 10 is a server computer of an integrated reservation service. The integrated reservation service is a service for receiving travel-related reservations in an integrated manner. For example, the integrated reservation service receives a reservation for lodging facilities, a tour, a train ticket, a bus ticket, or a rental car. A control unit 11 includes at least one processor. A storage unit 12 includes a volatile memory which is a RAM or the like, and a non-volatile memory which is a hard disk drive or the like. A communication unit 13 include at least one of a communication interface for wired communication or a communication interface for wireless communication.

The integrated reservation service is an example of a first service. In the description, “integrated reservation service” can accordingly be read as the first service. The first service can be any service and is not limited to a travel reservation service. For example, the first service may be an electronic commerce transaction service, a financial service, a payment service, a communication service, an insurance service, a video streaming service, or a social networking service.

The hotel server 20 is a server computer of a hotel program service. The hotel program service is a service for giving various privileges to a member who uses a hotel. For example, the hotel program service provides a service for enabling a member to use a hotel under favorable conditions, such as a stay at a members-only price, issuing of reward points, and early check-in or late check-out. A control unit 21, a storage unit 22, and a communication unit 23 have the same physical configurations as the physical configurations of the control unit 11, the storage unit 12, and the communication unit 13, respectively.

The hotel program service is an example of a second service. In the description, “hotel program service” can be read as the second service. The second service is a service that is not the first service. In the at least one embodiment, a case in which a provider of the first service and a provider of the second service differ from each other is described. However, the first service and the second service may be provided by the same provider. The second service can be any service and is not limited to a hotel program service. For example, the second service may be an electronic commerce transaction service, a financial service, a payment service, a communication service, an insurance service, a video streaming service, or a social networking service.

The user terminal 30 is a computer of a user. For example, the user terminal 30 is a smart phone, a personal computer, a tablet computer, or a wearable terminal. A control unit 31, a storage unit 32, and a communication unit 33 have the same physical configurations as the physical configurations of the control unit 11, the storage unit 12, and the communication unit 13, respectively. An operation unit 34 is an input device which is a touch panel or the like. A display unit 35 is a liquid crystal display or an organic EL display.

Programs or data to be separately stored in the integrated reservation server 10, the hotel server 20, and the user terminal 30 may be supplied via the Internet N. Alternatively, a program or data stored on an information storage medium may be supplied via a reading unit (for example, an optical disc drive or a memory card slot) for reading a computer-readable information storage medium, or via an input/output unit (for example, a USB port) for inputting data from and outputting data to an external device.

### 2. Outline of Member Registration System

In the at least one embodiment, a premise is that the user has completed member registration to the integrated reservation service but has not completed member registration to the hotel program service. The user accordingly has a user ID for logging in to the integrated reservation service but not a user ID for logging in to the hotel program service. The user ID in the integrated reservation service is hereinafter referred to as “first user ID,” and the user ID in the hotel program service is hereinafter referred to as “second user ID.”

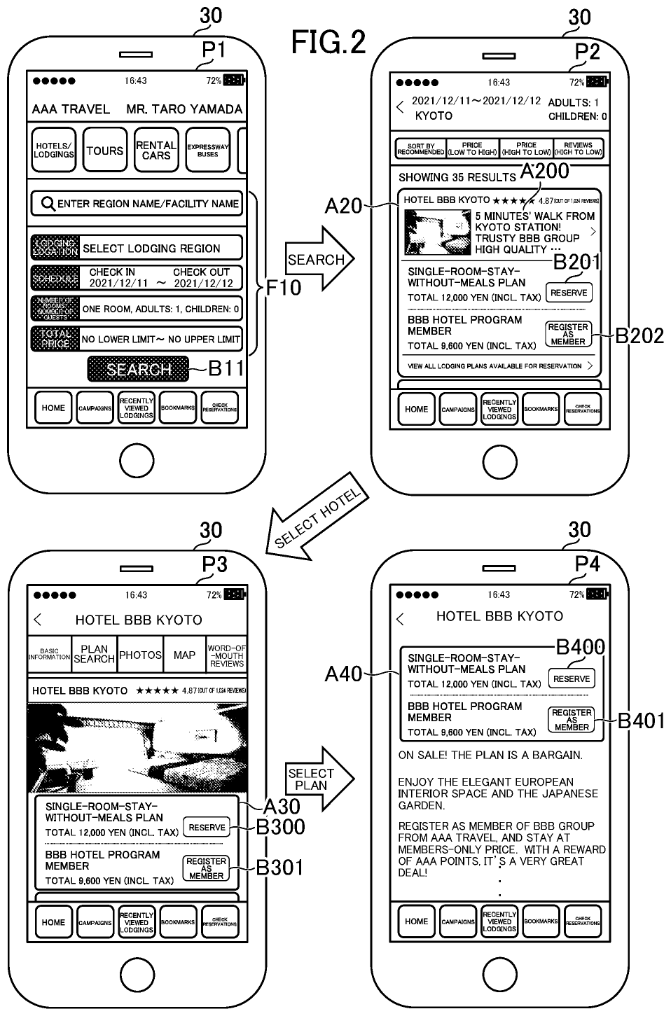

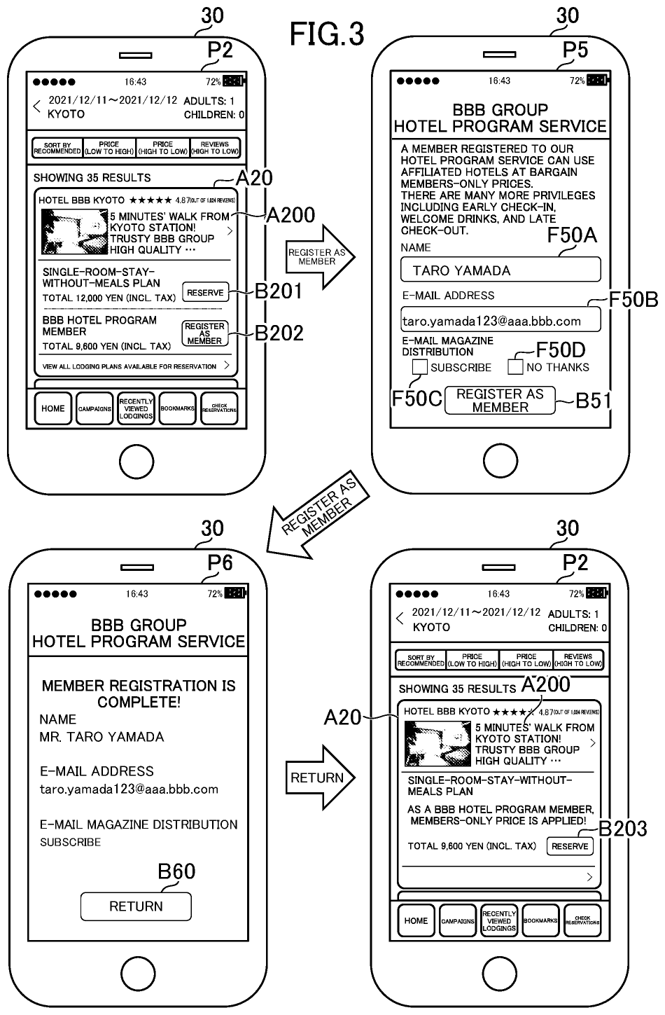

FIG. 2 and FIG. 3 are diagrams for illustrating an example of shifts between pages in a case in which the user uses the integrated reservation service. The pages are individual screens displayed on the display unit 35. In the at least one embodiment, a case in which pages of FIG. 2 and FIG. 3 are displayed on an application of the integrated reservation service installed on the user terminal 30 is described. However, the pages may be displayed on a browser. The application of the integrated reservation service is hereinafter referred to as “integrated reservation app.”

For example, when the integrated reservation app of the user terminal 30 is activated, processing for logging the user in to the integrated reservation service is executed. When the user logs in to the integrated reservation service, a top page P1 of the integrated reservation service is displayed on the display unit 35. The user inputs a region, a schedule, and other search criteria to fields F10. When the user selects a button B11 with the search criteria input, a search result page P2 reflecting the search criteria is displayed on the display unit 35.

For example, various types of information about one of hotels that match the search criteria input by the user are displayed in a display area A20 of the search result page P2. When the user scrolls down the search result page P2, the display area A20 of another of the hotels is displayed. In the example of FIG. 2, pieces of information including an image, a review score, a description, and a standard accommodation plan of “Hotel BBB Kyoto,” which is a match to the search criteria, are displayed in the display area A20. It is premised that “Hotel BBB Kyoto” is affiliated with “BBB Group,” which is a hotel group providing the hotel program service. “BBB Group” has a cooperative relationship with “AAA Travel,” which provides the integrated reservation service.

For example, a price of the standard plan of “Hotel BBB Kyoto” is displayed in the display area A20. In the at least one embodiment, a non-member price for non-members who are not members of the hotel program service and a members-only price for members of the hotel program service are displayed in the display area A20. The non-member price displayed in the display area A20 can be said as a price for members of the integrated reservation service.

In the example of FIG. 2, the non-member price of a “single-room-stay-without-meals plan,” which is a standard plan of “Hotel BBB Kyoto,” is 12,000 yen. The members-only price of this plan is 9,600 yen. However, at the time of FIG. 2, the user is not a member of the hotel program service, and accordingly cannot use this plan at the members-only price. For example, when the user selects a display area A200 displaying an outline of the hotel, a hotel details page P3 is displayed on the display unit 35.

The user can operate on the hotel details page P3 so that detailed information, for example, basic information and a map, of the hotel is displayed. The user can also search for plans prepared by the hotel on the hotel details page P3. Information of one of the plans is displayed in a display area A30 of the hotel details page P3. In the display area A30, the non-member price and the members-only price are displayed as in the display area A20. When the user scrolls down the hotel details page P3, the display area A30 of another of the plans is displayed. When the user selects the display area A30 of one plan, a plan details page P4 displaying details of this plan is displayed on the display unit 35.

The plan details page P4 displays detailed information, for example, a description and an image, of the plan selected by the user. In a display area A40 of the plan details page P4, the non-member price and the members-only price are displayed as in the display areas A20 and A30. When the plan that is being displayed is agreeable to the user, the user books the hotel according to the displayed plan. The user may return to one of previously displayed pages to search for a hotel or a plan anew.

In the at least one embodiment, the user can select a plan and book a hotel from any page out of the search result page P2, the hotel details page P3, and the plan details page P4. However, at the time of FIG. 2, the user is not a member of the hotel program yet, and accordingly cannot book a hotel at the members-only price. When having no intention of becoming a member of the hotel program service, the user selects buttons B201, B300, and B400 to book the hotel at the non-member price.

In the at least one embodiment, member registration to the hotel program service is executable from the integrated reservation service. As illustrated in FIG. 3, when the user selects a button B202 of the search result page P2, member registration of the hotel program service is started. The user may also select a button B301 of the hotel details page P3 or a button B401 of the plan details page P4 to start member registration of the hotel program service.

When the member registration is started, a member registration page P5 for inputting information required for the member registration to the hotel program service is displayed on the display unit 35. This information is hereinafter referred to as “second member information.” The second member information is information registered to the hotel program service along with the second use ID. In the at least one embodiment, three pieces of information which are a name, an e-mail address, and whether to receive distribution of an e-mail magazine are given as an example of the second member information. However, the second member information can be any type of information, and is not limited to the example of the at least one embodiment. The second member information may be other types of information, for example, an address, a phone number, a birth date, an age, or a gender.

The member registration page P5 is not a page provided by the hotel program service, and is a page provided by the integrated reservation service. The member registration page P5 is accordingly displayed as a page on the integrated reservation app. In the example of FIG. 3, during a period from the selection of the button B202 by the user to the display of the member registration page P5, access to the integrated reservation server 10 from the user terminal 30 occurs, but access to the hotel server 20 from the user terminal 30 does not occur. Even when the user terminal 30 has an application of the hotel program service installed therein, the application is not activated. The member registration page P5 is accordingly displayed with the integrated reservation app kept in the foreground.

In a case in which the pages of FIG. 2 and FIG. 3 are displayed on a browser instead of the integrated reservation app, the member registration page P5 belongs to a domain of the integrated reservation service. Shifts between screens of the pages are completed within the domain of the integrated reservation service, and there is accordingly no redirect to a domain of the hotel program service. The domain of the member registration page P5 and a domain of another page of the integrated reservation service may be the same, or different domains managed by the integrated reservation service may be used for the member registration page P5 and another page of the integrated reservation service.

For example, the member registration page P5 displays fields F50A to F50D for inputting the second member information. In the following description, the fields F50A to F50D are simply referred to as “fields F50” when distinction of the fields F50A to F50D from one another is not required. In the at least one embodiment, information registered in the integrated reservation service is automatically input to some of the fields F50. This information is hereinafter referred to as “first member information.” In the example of FIG. 3, two pieces of the first member information which are the name and the e-mail address are automatically input to the fields F50A and F50B. No information is automatically input to the fields F50C and F50D for inputting whether to receive distribution of an e-mail magazine.

The user can change the name in the field F50A when, for example, the name automatically input to the field F50A is an original family name. When the user wishes to register another e-mail address other than the e-mail address automatically input to the field F50B, the user can change the e-mail address in the field F50B. The user who wishes to receive distribution of an e-mail magazine checks the field F50C. The user who does not wish to receive distribution of an e-mail magazine checks the field F50D.

When the user selects a button B51, the user terminal 30 transmits the second member information input to the fields F50 to the integrated reservation server 10. The integrated reservation server 10 transfers the second member information received from the user terminal 30 to the hotel server 20. The hotel server 20 receives the second member information from the integrated reservation server 10, and then executes the member registration of the hotel program service. When the member registration is completed, a registration completion page P6 indicating completion of the member registration is displayed on the display unit 35. In the at least one embodiment, the registration completion page P6 is displayed as a page on the integrated reservation app as well.

When the user selects a button B60, the screen returns to the search result page P2 displayed before the member registration page P5 is displayed. As in the search result page P2 in a lower right part of FIG. 3, the user who has become a member of the hotel program service can now book the hotel at the members-only price by selecting a button B203. In the example of FIG. 3, once member registration of the hotel program service is complete, the members-only price alone is displayed in the display area A20. However, the non-member price may be kept displayed even after completion of the member registration of the hotel program service.

Although the search result page P2 is taken as an example in FIG. 3, the hotel can now similarly be booked at the members-only price in the display area A30 of the hotel details page P3 and the display area A40 of the plan details page P4. In addition, after the user becomes a member of the hotel program service, any other hotel affiliated with “BBB Group” can now be booked at a members-only price as is the case for “Hotel BBB Kyoto.” Before the user becomes a member of the hotel program service, member registration to the hotel program service is executable from the search result page P2, the hotel details page P3, or the plan details page P4 that displays information of another hotel affiliated with “BBB Group”, through the same steps as the steps illustrated in FIG. 3.

As described above, when the user starts member registration of the hotel program service from the integrated reservation service, the fields F50 for member registration are displayed on the member registration page P5 in the integrated reservation service. Input to just one member registration page P5 in the integrated reservation service by the user completes the member registration of the hotel program service. A burden on the user is lightened because completion of the member registration of the hotel program service does not require the user to input to a plurality of pages and does not involve calling up of a page of the hotel program service. The following is a description on details of the member registration system S.

### 3. Functions in at Least One Embodiment

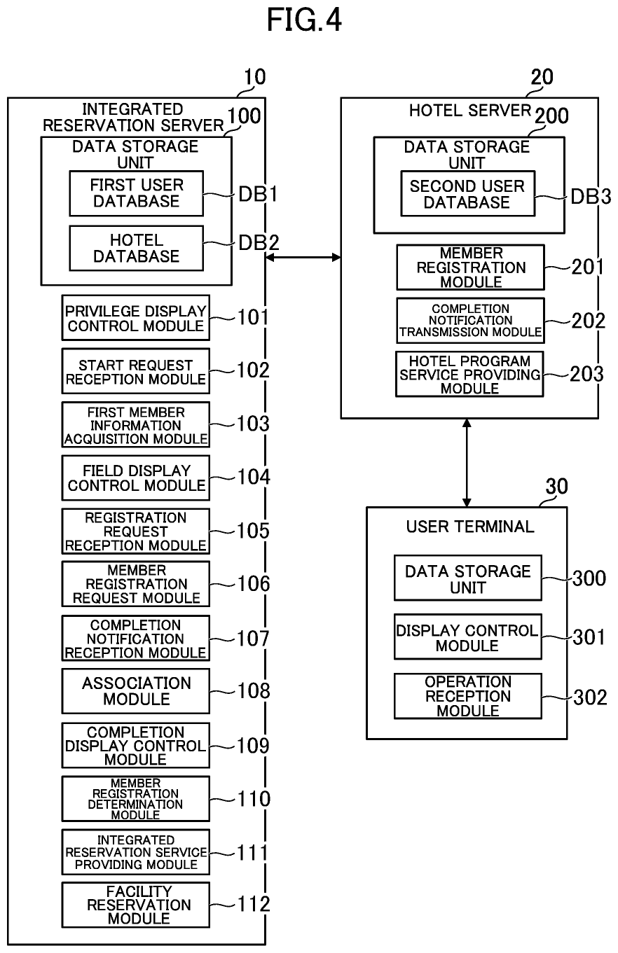

FIG. 4 is a function block diagram for illustrating an example of functions in the at least one embodiment.

### [3-1. Functions Implemented by Integrated Reservation Server]

A data storage unit 100 is implemented mainly by the storage unit 12. The rest of the functions are implemented mainly by the control unit 11.

### [Data Storage Unit]

The data storage unit 100 stores data required to provide the integrated reservation service. For example, the data storage unit 100 stores a first user database DB1 and a hotel database DB2.

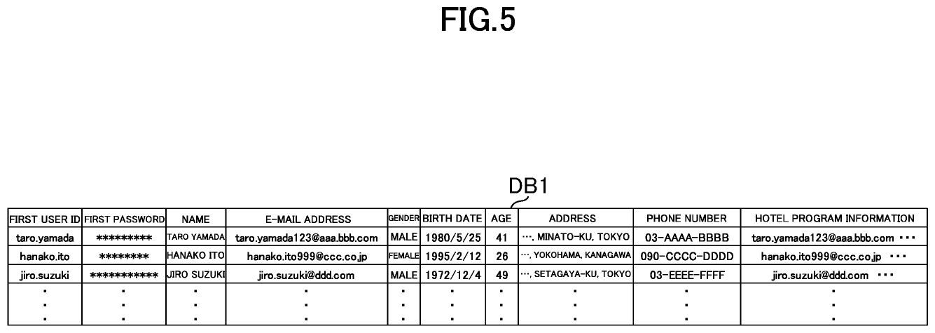

FIG. 5 is a table for showing an example of the first user database DB1. The first user database DB1 is a database in which information about each user registered to the integrated reservation service as a member is stored. For example, the first user ID, a first password, a name, an e-mail address, gender, a birth date, an age, an address, a phone number, and hotel program information are stored in the first user database DB1. Information stored in the first user database DB1 is not limited to the example of FIG. 5, and any type of information about a user may be stored. For example, information such as a hotel reservation history, a hotel viewing history, or a rank of the user may be stored in the first user database DB1.

The first user ID is an example of first user identification information by which a user is identifiable in the integrated reservation service. The first user identification information can be any type of information and is not limited to the first user ID. For example, the first user identification information may be information called a user account, an e-mail address, or a phone number. The first user ID and the first password are used to log in to the integrated reservation service.

The name, the e-mail address, the gender, the birth date, the age, the address, and the phone number are an example of items related to the first member information. Accordingly, those pieces of information in the description can be read as items related to the first member information. The first member information can be any type of information registered in the integrated reservation service, and is not limited to the example of FIG. 5. For instance, the first member information may include an item such as whether to receive distribution of an e-mail magazine, an occupation, workplace location, a frequented place, taste, an account of a message app, or an SNS account.

The hotel program information is information about member registration of the hotel program service. For example, the hotel program information includes the second user ID, a name, an e-mail address, and whether to receive distribution of an e-mail magazine. The hotel program information can include any type of information and is not limited to the example of FIG. 5. For instance, the hotel program information may include a flag indicating whether member registration to the hotel program service is complete, or a rank of the user in the hotel program service.

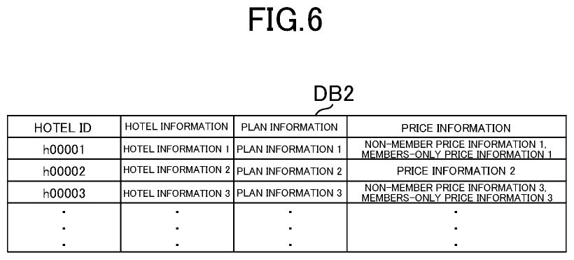

FIG. 6 is a table for showing an example of the hotel database DB2. The hotel database DB2 is a database in which information about each hotel that can be booked from the integrated reservation service is stored. For example, a hotel ID, hotel information, plan information, and price information are stored in the hotel database DB2. Information stored in the hotel database DB2 is not limited to the example of FIG. 6, and any type of information about the hotel can be stored. For instance, how many rooms of a specific plan is available may be stored in the hotel database DB2.

The hotel ID is an example of hotel identification information by which a hotel is identifiable. The hotel identification information can be any type of information and is not limited to a hotel ID. The hotel identification information may be another type of information, for example, a hotel name, an e-mail address of the hotel, or a phone number of the hotel. The hotel information is information about the hotel. For example, the hotel information includes a hotel name, an address, a phone number, a hotel image, and a hotel description. The hotel information may include information indicating whether the hotel is affiliated with the hotel program service. The plan information is information about a plan prepared by the hotel. For example, the plan information includes a plan name, a plan image, and a plan description.

The hotel information and the plan information are information displayed on the pages of FIG. 2 and FIG. 3. Those pieces of information are used as an index for a search for a hotel or a plan. Information to be used as the index can be any type of information, and is not limited to the example of FIG. 6. For instance, information such as a keyword specified by the hotel, an area to which the hotel belongs, word-of-mouth reviews of the hotel, or detailed information about facilities owned by the hotel can be used as the index.

The price information is information about a price of a plan prepared by the hotel. In the at least one embodiment, the price information of any hotel affiliated with “BBB Group” includes non-member price information and members-only price information. In the example of FIG. 6, a hotel having a hotel ID “h00001” and a hotel having a hotel ID “h00003” are affiliated with “BBB Group” and, accordingly, the price information of each of those hotels includes non-member price information and members-only price information. A hotel having a hotel ID “h00002” is not affiliated with “BBB Group” and, accordingly, there is no distinction between a non-member price and a members-only price for this hotel.

The non-member price information is information about a price for non-members who are not members of the hotel program service. In a case of a plan having a price that varies depending on the date of use, a relationship between the date of use and a price of the plan is indicated in the price information. In a case of a plan having a price that varies depending on a condition other than the date of use, for example, the day of the week or the season, a relationship between the other condition and a price of the plan is indicated in the price information.

The members-only price information is information about a price for members of the hotel program service. Although a numerical value indicating the members-only price itself may be indicated in the members-only price information, a rate of a discount from the non-member price is indicated in the members-only price information in the at least one embodiment. The discount rate indicated in the members-only price information may be a rate of a discount from a price for a reservation made directly to the hotel program service, or a rate of a discount from a price for the integrated reservation service. In a case in which the members-only price is displayed on the pages of FIG. 2 and FIG. 3, the members-only price is calculated by subtracting a discount amount which is derived from the discount rate indicated in the members-only price information from a price indicated in the non-member price information.

When a discount for members of the hotel program service applies to only some of plans, the plans to which the discount applies may be indicated in the members-only price information. In this case, a non-member price instead of a members-only price is displayed for a plan that is not indicated in the members-only price information, even though the plan is provided by a hotel affiliated with “BBB Group.” In a case in which the discount rate is varied from plan to plan, the discount rate of each plan is indicated in the members-only price information. Similarly, when the discount rate is varied depending on another condition, the discount rate of each element of the another condition is indicated in the members-only price information. The members-only price is calculated dynamically from a discount rate that applies to an element of the condition observed when the pages of FIG. 2 and FIG. 3 are displayed.

### [Privilege Display Control Module]

A privilege display control module 101 displays, on the search result page P2, the hotel details page P3, or the plan details page P4, a members-only price to be applied when the user becomes a member of the hotel program service. The search result page P2, the hotel details page P3, or the plan details page P4 is an example of a page for receiving a start request. Accordingly, descriptions of those pages can be read as a description of the page for receiving the start request. This page can be any page and is not limited to those pages. For example, issuing of the start request may be executable on the top page P1 of the integrated reservation service, or may be executable on a screen displaying a list of plans of a hotel.

The members-only price is an example of privilege information. Accordingly, a description of the members-only price displayed on the pages of FIG. 2 and FIG. 3 can be read as a description of the privilege information. The privilege information is information about a privilege given when the user becomes a member of the hotel program service. The privilege information can be displayed in any format as long as contents of the privilege are identifiable. For example, the privilege information may be text, a numeral, an icon, or an image. When early check-in is the privilege, the privilege information indicates a check-in time. When late check-out is the privilege, the privilege information indicates a check-out time. When another privilege is provided to the user, the privilege information may indicate the another privilege.

The contents of the privilege are stored in the hotel database DB2 or another database. Depending on search criteria input by the user, it may not be possible to display details of the privilege. In this case, it is sufficient to display rough contents of the privilege as privilege information. For example, when the user does not input the date of use of a hotel, a specific discounted price cannot be displayed in some cases. Thus, in such cases, rough contents of the privilege, such as “a maximum of 20% off for members,” may be displayed as the privilege information.

### [Start Request Reception Module]

A start request reception module 102 receives a start request for starting member registration of the hotel program service which is issued by the user in the integrated reservation service. The start request is a request indicating a start of procedures or application for the member registration. The start request differs from a registration request for executing the member registration. After the start request is issued, information required for the member registration is input. The information required for the member registration is not input before the start request is issued. That is, issuing of the start request alone does not cause registration of the second member information in the hotel program service.

In the at least one embodiment, the start request reception module 102 is implemented by the integrated reservation server 10. The start request is accordingly issued by the user terminal 30 through transmission of data having a predetermined format. The start request reception module 102 receives this data from the user terminal 30, to thereby receive the start request. The start request includes user identification information of the user who has transmitted the start request. This user identification information may be a user ID or another type of information by which a user who is logged in is identifiable.

In the integrated reservation service in the at least one embodiment, a plurality of hotels including hotels related to the hotel program service are searched for hotels that match search criteria specified by the user. For example, in the integrated reservation service, hotels registered in the hotel database DB2 are searched for, based on search criteria input to the fields F10 of the top page P1. Publicly known search engines may be used to execute the hotel search. Hotels that match the search criteria specified by the user are displayed as search results on the search result page P2.

A hotel searched for in the integrated reservation service is an example of a second service item. Accordingly, “hotel” in the description can be read as the second service item. The second service item is an item related to the second service, an example of which is the hotel program service. “Item” is a search object searched for by a user. For example, the second service item may be a plan of a hotel, a room in the hotel, a facility in the hotel, or a condition of a stay.

For example, the start request reception module 102 receives, on the search result page P2 including information about hotels searched for in the integrated reservation service, the start request issued by the user. When the user selects the button B202 of the search result page P2, the user terminal 30 transmits the start request to the integrated reservation server 10. The start request reception module 102 receives, when the user selects the button B202 of the search result page P2, the data corresponding to the start request from the user terminal 30, to thereby receive the start request issued by the user. The search result page P2 is an example of a second service item page. Accordingly, a description of the search result page P2 can be read as a description of the second service item page. The second service item page is a page displaying information about the second service item, an example of which is a hotel. The second service item page can be any page on which some information about the second service item is displayed, and is not limited to the search result page P2. For example, the hotel details page P3 and the plan details page P4 include some information about a hotel searched for by the user, and accordingly may qualify as pages including the second service item.

In the integrated reservation service of the at least one embodiment, hotel information related to the hotel program service can be provided to the user in stages. The hotel information is information about a hotel. For example, the hotel information includes a hotel name, an image of the hotel, a description of the hotel, word-of-mouth reviews of the hotel, a plan name, an image of a plan, or a description of the plan. For example, the search result page P2 displays the roughest version of the hotel information. The hotel details page P3 displays a more detailed version of the hotel information than the version of the hotel information displayed on the search result page P2. The plan details page P4 displays a more detailed version of the hotel information than the version of the hotel information displayed on the hotel details page P3. In the at least one embodiment, the hotel information becomes progressively detailed in the order of the search result page P2, the hotel details page P3, the plan details page P4.

The hotel information is an example of second service information. Accordingly, a description of the hotel information can be read as a description of the second service information. The second service information is information about the second service, an example of which is the hotel program service. The second service information can be any type of information relevant to the second service. For example, when the second service is an electronic commerce transaction service, the second service information may be information about a commercial product that can be purchased in the electronic commerce transaction service. To give another example, when the second service is a financial service, the second service information may be information about a function usable in the financial service.

For example, the start request reception module 102 can receive the start request irrespective of what stage of the hotel information is to be provided. The user can issue the start request on any page out of the search result page P2, the hotel details page P3, and the plan details page P4. For example, the user can issue the start request by selecting the button B202 of the search result page P2 displaying the roughest version of the hotel information. The user can issue the start request by selecting the button B301 of the hotel details page P3 displaying the intermediately detailed version of the hotel information. The user can issue the start request by selecting the button B401 of the plan details page P4 displaying the most detailed version of the hotel information. The start request reception module 102 receives the start request issued on any page out of the search result page P2, the hotel details page P3, and the plan details page P4.

### [First Member Information Acquisition Module]

A first member information acquisition module 103 acquires the first member information of the user in the integrated reservation service. In the at least one embodiment, the first member information is stored in the first user database DB1, and the first member information acquisition module 103 accordingly acquires the first member information by referring to the first user database DB1. The first member information may be stored in a database other than the first user database DB1, or on a computer other than the integrated reservation server 10. In this case, it suffices that the first member information acquisition module 103 acquires the first member information from the other database or the other computer.

In the at least one embodiment, the second member information including three items, which are the name of the user, an e-mail address, and whether to receive distribution of an e-mail magazine, is registered in the hotel program service. Two out of those three, namely, the name and the e-mail address, are registered also in the integrated reservation service as items of the first member information. The first member information acquisition module 103 accordingly acquires the two items, which are the name of the user and the e-mail address. When whether to receive distribution of an e-mail magazine which is registered in the integrated reservation service is to be adopted in the hotel program service as well, the first member information acquisition module 103 may acquire the first member information including the three items, which are the name of the user, the e-mail address, and whether to receive distribution of an e-mail magazine.

Settings indicating which item out of the items stored in the first user database DB1 is to be adopted as an item of the second member information may be specified by an administrator of the integrated reservation service. The settings are recorded in the data storage unit 100. When there are a plurality of hotel program services, settings indicating which item is to be adopted as an item of the second member information are recorded for each of the plurality of hotel program services separately in the data storage unit 100. It suffices that the first member information acquisition module 103 acquires the first member information associated with a hotel program service to which the user is about to register as a member.

### [Field Display Control Module]

A field display control module 104 displays the fields F50 for member registration on the one member registration page P5 in the integrated reservation service when the start request reception module 102 receives the start request. The fields F50 are fields for inputting the second member information to be registered in the hotel program service. In the at least one embodiment, the fields F50 to which text can freely be input are taken as an example. However, various fields can be used as fields for member registration. For example, a pulldown menu, a checkbox, or a radio button may be used as a field for member registration.

The member registration page P5 is a page for receiving, at once, input of pieces of the second member information required for member registration to the hotel program service. Accordingly, in the at least one embodiment, a piece of the second member information that is additionally input after the second member information input to one page is registered in the hotel program service is not additionally registered in the hotel program service. After the user selects the button B202, B301, or B401 in order to issue the start request, the entire procedure of member registration is completed just by inputting to the member registration page P5.

The member registration page P5 may seemingly be divided into a plurality of screens. For example, when many pieces of the second member information are required for member registration of the hotel program service, the one member registration page P5 may seemingly be divided into a plurality of pages including a first page, a second page, a third page, and so on. In this case, the user can freely move back and forth between individual pages included in the one member registration page P5. Instead of executing input to the second and subsequent pages after a piece of second member information input to the first page is registered in the hotel program service, input pieces of the second member information are not registered in the hotel program service until input is executed on all pages, and, after input is complete on all pages, pieces of the second member information on all pages are registered at once.

In the at least one embodiment, the field display control module 104 is implemented by the integrated reservation server 10. The field display control module 104 accordingly transmits data for displaying the one member registration page P5 including the fields F50 to the user terminal 30, to thereby display the one member registration page P5 on the user terminal 30. This data can have any format, for example, a format used in screen display of a travel reservation app. In a case of using a browser to display the one member registration page P5, it suffices that the field display control module 104 transmits HTML data of the one member registration page P5, to thereby display the one member registration page P5 on the user terminal 30.

In the at least one embodiment, the field display control module 104 displays, on the one member registration page P5, the fields F50 to which the second member information to be registered in the hotel program service is automatically input based on the first member information acquired by the first member information acquisition module 103. Automatic input means setting the information as default values of the fields F50. That the second member information is displayed in the fields F50 without the user inputting the second member information through the operation unit 34 qualifies as automatic input.

The field display control module 104 displays, on the user terminal 30, the one member registration page P5 on which the first member information acquired by the first member information acquisition module 103 is automatically input to the fields F50 as the second member information. For example, the field display control module 104 displays, on the user terminal 30, the one member registration page P5 on which the name of the user and the e-mail address that have been registered as the first member information in the integrated registration service are automatically input to the fields F50 as the second member information.

The fields F50 may be designed so that pieces of the second member information that have automatically been input cannot be changed by the user. In the at least one embodiment, the fields F50 displayed on the one member registration page P5 by the field display control module 104 allow changes to automatically input pieces of the second member information. The field display control module 104 displays, on the user terminal 30, the one member registration page P5 on which the second member information is automatically input to the fields F50 that allow input from the user. The user can change the pieces of the second member information that have automatically been input to the fields F50. In the example of FIG. 3, even when the name and the e-mail address are automatically input to the field F50A and the field F50B, respectively, the user can change or delete the automatically input character strings by selecting the fields F50A and F50B.

In the at least one embodiment, the field display control module 104 displays, on the one member registration page P5, a first field to which the second member information is automatically input and a second field which requires input by the user. In the example of FIG. 3, the name and the e-mail address are automatically input and, accordingly, the fields F50A and F50B for the name and the e-mail address each qualify as the first field. Whether to receive distribution of an e-mail magazine is not automatically input and, accordingly, the fields F50C and F50D each qualify as the second field. A description of the fields F50A and F50B can accordingly be read as a description of the first field. A description of the fields F50C and F50D can accordingly be read as a description of the second field.

### [Registration Request Reception Module]

A registration request reception module 105 receives the registration request for completing the member registration of the hotel program service which is issued by the user in the integrated reservation service. The registration request is a request for registering the second member information in the hotel program service. The registration request is a request issued after the start request. During a period from the issuing of the start request to the issuing of the registration request, no request is issued by the user. After issuing the start request, the user can complete the member registration to the hotel program service by issuing the registration request. The user is accordingly not required to execute input in two stages in order to register the second member information, and executing input once completes the member registration.

In the at least one embodiment, the registration request reception module 105 is implemented by the integrated reservation server 10, and the registration request is accordingly issued by transmitting data having a predetermined format from the user terminal 30. The registration request reception module 105 receives data from the user terminal 30, to thereby receive the registration request. The registration request includes user identification information of the user who has transmitted the registration request. The user identification information may be a user ID or another type of information by which a user who is logged in is identifiable.

For example, when the user selects the button B51 of the member registration page P5, the user terminal 30 transmits the registration request to the integrated reservation server 10. The registration request reception module 105 receives data corresponding to the registration request from the user terminal 30 when the user selects the button B51 of the member registration page P5, to thereby receive the registration request issued by the user. The registration request includes the second member information input to the fields F50.

### [Member Registration Request Module]

A member registration request module 106 requests the hotel server 20 to execute member registration, based on input from the user to the one member registration page P5. The input from the user is some operation performed on the one member registration page P5. The input from the user to the one member registration page P5 may mean input to the fields F50, or may mean selection of the button B51 instead of input to the fields F50. The member registration request module 106 may transmit data having a predetermined format to the hotel server 20 to request member registration.

The hotel server 20 is an example of a second service server. Accordingly, a description of the hotel server 20 can be read as a description of the second service server. The second service server is a server computer associated with the second service, an example of which is the hotel program service. The second service server can be any server computer that is managed by the provider of the second service.

The request issued by the member registration request module 106 is similar to the registration request received by the registration request reception module 105, but is a request issued from the integrated reservation server 10 to the hotel server 20, whereas the registration request received by the registration request reception module 105 is issued from the user terminal 30 to the integrated reservation server 10. The request issued by the member registration request module 106 and the registration request received by the registration request reception module 105 may have the same data format or different data formats. When the registration request is received from the user terminal 30, the member registration request module 106 requests the hotel server 20 to execute member registration based on the second member information included in the registration request.

In the at least one embodiment, the second member information is automatically input to the fields F50, and the member registration request module 106 accordingly requests the hotel program service system to execute member registration based on the second member information automatically input to the fields F50. For example, in a case in which the second member information automatically input to the fields F50 is changed by the user, the member registration request module 106 requests the hotel server 20 to execute member registration based on the changed second member information. The member registration request module 106 requests the hotel server 20 to execute member registration based on a piece of the second member information automatically input to the first field, examples of which are the fields F50 for a name and for an e-mail address, and input from the user to the second field, examples of which are the fields F50 for specifying whether to receive distribution of an e-mail magazine.

### [Completion Notification Reception Module]

A completion notification reception module 107 receives a completion notification from the hotel server 20. The completion notification is a notification informing that member registration to the hotel program service has been completed. The completion notification is issued by transmission of data having a predetermined format. The integrated reservation server 10 can detect that the member registration to the hotel program service has been completed by receiving the completion notification.

### [Association Module]

An association module 108 associates the first user ID of the user in the integrated reservation service and the second user ID of the user in the hotel program service with each other when the member registration of the hotel program service is completed. Associating the first user ID and the second user ID with each other is to enable a search for one of the first user ID and the second user ID with the use of another of the first user ID and the second user ID. In the at least one embodiment, storing the second user ID in a record of the first user database DB1 that holds the first user ID qualifies as associating the first user ID and the second user ID with each other.

For example, when the member registration of the hotel program service is completed, the hotel server 20 transmits the completion notification including the second user ID to the integrated reservation server 10. The integrated reservation server 10 receives the completion notification, and the association module 108 associates the first user ID of the user who has issued the start request and the registration request with the second user ID included in the completion notification. In the at least one embodiment, the association module 108 stores the second user ID as the hotel program information in the same record of the first user database DB1 that holds the first use ID, to thereby associate the first user ID and the second user ID with each other.

### [Completion Display Control Module]

A completion display control module 109 displays, in a case in which the completion notification reception module 107 receives the completion notification, a registration completion page P6 indicating completion of the member registration as a page in the integrated reservation service. In the at least one embodiment, the completion display control module 109 is implemented by the integrated reservation server 10, and accordingly transmits data for displaying the registration completion page P6 to the user terminal 30, to thereby display the registration completion page P6 on the user terminal 30. This data can have any format, for example, a format used in screen display of a travel reservation app. In a case of using a browser to display the registration completion page P6, it suffices that the completion display control module 109 transmits HTML data of the registration completion page P6, to thereby display the registration completion page P6 on the user terminal 30. In this case, the registration completion page P6 is displayed as a page belonging to a domain of the integrated reservation service.

### [Member Registration Determination Module]

A member registration determination module 110 determines whether a user is a member of the hotel program service, based on the association between the first user ID and the second user ID. When the second user ID is not associated with the first user ID, the member registration determination module 110 determines that the user is not a member of the hotel program service. When the second user ID is associated with the first user ID, the member registration determination module 110 determines that the user is a member of the hotel program service.

### [Integrated Reservation Service Providing Module]

An integrated reservation service providing module 111 provides the integrated reservation service to users. Providing the integrated reservation service is to provide functions usable from the integrated reservation service. For example, a user can search for a hotel from the integrated reservation service. Providing a search engine for searching for a hotel qualifies as providing the integrated reservation service. To give another example, providing a search engine for searching for a plan, or providing a screen (for example, the pages of FIG. 2 and FIG. 3) for booking a hotel also qualifies as providing the integrated reservation service. In addition, providing some function related to the integrated reservation service qualifies as providing the integrated reservation service.

For example, in the integrated reservation service, the integrated reservation service providing module 111 provides a hotel item related to the hotel program service to a user, based on a result of the determination by the member registration determination module 110. The hotel item is an item related to a hotel that can be booked from the integrated reservation service. In the at least one embodiment, the hotel item is a plan of a hotel. The hotel item is an example of the second service item. Accordingly, a description of the hotel item can be read as a description of the second service item. The second service item can be any item relevant to the second service. When the user is determined to be a member of the hotel program service, the integrated reservation service providing module 111 provides, to the user, contents of a service that are not provided when the user is not determined to be a member of the hotel program service. That is, the integrated reservation service providing module 111 provides a service limited to members of the hotel program service in the integrated reservation service.

For example, when the user is determined to be a member of the hotel program service, the integrated reservation service providing module 111 provides the integrated reservation service to the user in a manner that gives a predetermined privilege. When the user is not determined to be a member of the hotel program service, the integrated reservation service providing module 111 provides the integrated reservation service to the user in a manner that does not give the predetermined privilege. In the at least one embodiment, the privilege is that a hotel can be booked at a members-only price, and the integrated reservation service providing module 111 accordingly provides the integrated reservation service to the user in a manner that gives the privilege by displaying the button B203 for booking a hotel at a members-only price on the search result page P2.

### [Facility Reservation Module]

In the integrated reservation service in the at least one embodiment, booking of a hotel related to the hotel program service is received. A facility reservation module 112 handles booking of the hotel by a user. The hotel is an example of the facility. Accordingly, a description of the hotel can be read as a description of the facility. The facility can be any facility that can be booked from the first service, an example of which is the integrated reservation service, and is not limited to a hotel. For example, the facility may be a restaurant, a café, a sightseeing facility, a play facility, or a public facility. In a case in which member registration is completed prior to reception of booking of the hotel by the user, the facility reservation module 112 handles booking of the hotel by the user as booking by a member of the hotel program service. For example, the facility reservation module 112 executes booking of the hotel by the user at a members-only price. Processing used in a publicly known integrated reservation service is applicable to processing required for the booking of the hotel.

Once the member registration of the hotel program service is complete, the user can book at a members-only price from the integrated reservation service as described above. It suffices that completion of the member registration of the hotel program service is observed any time at which completion of the member registration becomes somehow recognizable. For example, completion of the member registration of the hotel program service may be observed at any time out of the time when a record is created in the second user database DB3, the time when the hotel server 20 transmits the completion notification to the integrated reservation server 10, the time when the integrated reservation server 10 receives the completion notification from the hotel server 20, and the time when a record is updated in the first user database DB1.

### [3-2. Functions Implemented by Hotel Server]

A data storage unit 200 is implemented mainly by the storage unit 22. The rest of the functions are implemented mainly by the control unit 21.

### [Data Storage Unit]

The data storage unit 200 stores data required to provide the hotel program service. For example, the data storage unit 200 stores a second user database DB3.

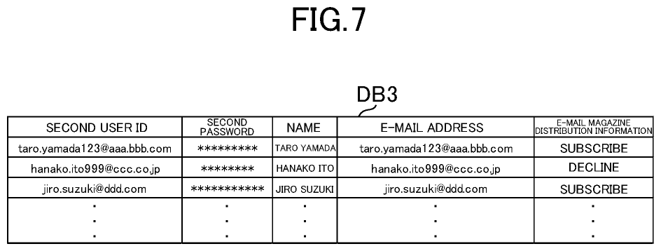

FIG. 7 is a table for showing an example of the second user database DB3. The second user database DB3 is a database in which information about each user registered to the hotel program service as a member is stored. For example, the second user ID, a second password, a name, an e-mail address, and e-mail magazine information are stored in the second user database DB3. Information stored in the second user database DB3 is not limited to the example of FIG. 7, and any type of information about a user may be stored. For example, a rank of the user in the hotel program service may be stored in the second user database DB3.

The second user ID is an example of second user identification information by which a user is identifiable in the hotel reservation service. The second user identification information can be any type of information and is not limited to the second user ID. For example, the second user identification information may be information called a user account, an e-mail address, or a phone number. In the example of FIG. 7, a case in which an e-mail address input as the second member information is used as the second user ID is illustrated. The second user ID and the second password are used to log in to the hotel program service. The second password may be specified on the member registration page P5, or a temporary second password may automatically be generated at the time of member registration to be changed by the user to a formal second password. The e-mail magazine information is information indicating whether to receive distribution of an e-mail magazine.

### [Member Registration Module]

A member registration module 201 executes member registration of the hotel program service based on the request issued by the member registration request module 106. This request includes information required for the member registration of the hotel program service. For example, the member registration module 201 issues the second user ID of a user who newly becomes a member of the hotel program service. The member registration module 201 stores the issued second user ID and the second member information of the user in association with each other in the second user database DB3. In the at least one embodiment, an e-mail address input as the second member information is used as the second user ID, and the member registration module 201 accordingly issues, as a new second user ID, the e-mail address input as the second member information. The member registration module 201 stores the issued new second user ID and the second member information in the second user database DB3 in association with each other.

### [Completion Notification Transmission Module]

A completion notification transmission module 202 transmits a completion notification indicating that the member registration of the hotel program service has been completed to the integrated reservation server 10. The completion notification transmission module 202 transmits the completion notification to the integrated reservation server 10 when the member registration module 201 completes the processing of the member registration of the hotel program service.

### [Hotel Program Service Providing Module]

A hotel program service providing module 203 provides the hotel program service to users. Providing the hotel program service is to provide a function usable from the hotel program service. For example, a user can search for a hotel from the hotel program service. Providing a search engine for searching for a hotel qualifies as providing the hotel program service. To give another example, providing a search engine for searching for a plan or providing a screen for booking a hotel also qualifies as providing the hotel program service.

Plans available for reservation from the hotel program service may be the same as or differ from plans available for reservation from the integrated reservation service. The hotel program service may have an original plan unavailable in the integrated reservation service. Conversely, the integrated reservation service may have an original plan unavailable in the hotel program service. Other than the above, providing some function related to the hotel program service qualifies as providing the hotel program service. For example, execution of processing for using reward points earned in the hotel program service qualifies as providing the hotel program service. Once a user becomes a member of the hotel program service, contents of a reservation made by the user from the integrated reservation service can be checked from the hotel program service as well.

### [3-3. Functions Implemented by User Terminal]

A data storage unit 300 is implemented mainly by the storage unit 32. A display control module 301 and an operation reception module 302 are implemented mainly by the control unit 31.

### [Data Storage Unit]

The data storage unit 300 stores data required for utilization of the integrated reservation service by the user. For example, the data storage unit 300 stores the integrated reservation app. After the user becomes a member of the hotel program service, the data storage unit 300 stores data required for utilization of the hotel program service by the user. For example, in a case in which the hotel program service distributes a dedicated application, the data storage unit 300 stores this application.

### [Display Control Module]

The display control module 301 displays, on the display unit 35, a page for using the integrated reservation service. For example, the display control module 301 displays the pages of FIG. 2 and FIG. 3 on the display unit 35. The display control module 301 displays, on the display unit 35, another page which is a page for submitting a request to book a hotel. The display control module 301 displays, on the display unit 35, a page for using the hotel program service.

### [Operation Reception Module]

The operation reception module 302 receives operation performed by the user to use the integrated reservation service. For example, the operation reception module 302 receives input to the pages of FIG. 2 and FIG. 3. The operation reception module 302 receives operation for submitting a request to book a hotel. The operation reception module 302 receives operation performed by the user to use the hotel program service.

### 4. Processing in at Least One Embodiment

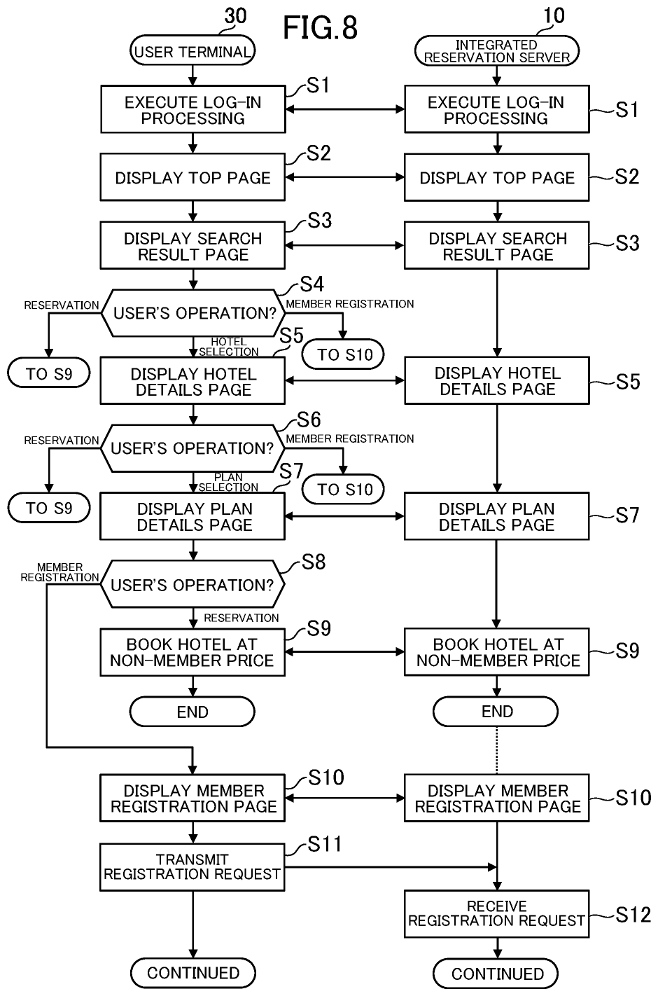

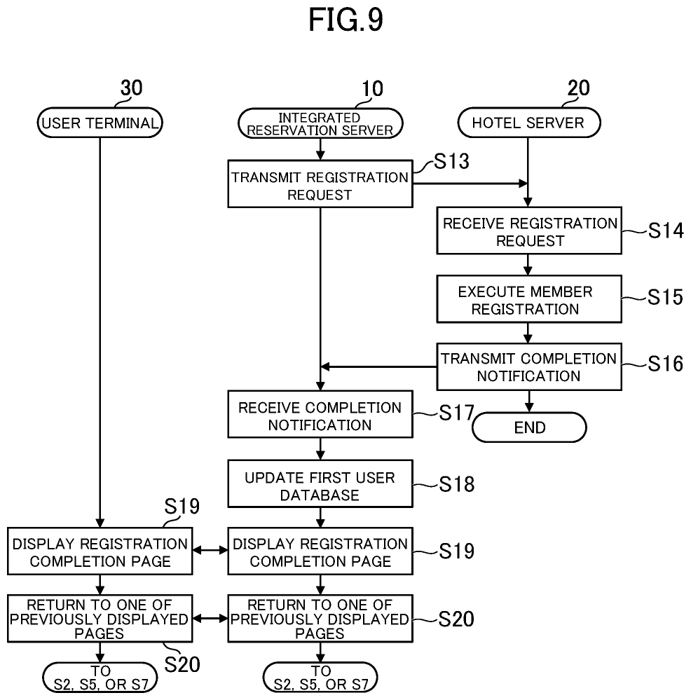

FIG. 8 and FIG. 9 are flow charts for illustrating an example of processing in the at least one embodiment. A premise here is that, prior to execution of the processing of FIG. 8 and FIG. 9, the user is a member of the integrated reservation service but is not a member of the hotel program service.

As illustrated in FIG. 8, when the integrated reservation app is activated on the user terminal 30, log-in processing for logging the user in to the integrated reservation service is executed between the integrated reservation server 10 and the user terminal 30 (Step S1). In Step S1, input of the first user ID and the first password may be demanded, or, in a case in which information indicating that the user has logged in to the integrated reservation service in the past is stored on the user terminal 30, this information may be used instead of demanding input of the first user ID and the first password.

When the user logs in to the integrated reservation service, processing for displaying the top page P1 of the integrated reservation service is executed between the integrated reservation server 10 and the user terminal 30 (Step S2). Processing for searching for hotels and displaying the search result page P2 is executed between the integrated reservation server 10 and the user terminal 30, based on search criteria input by the user to the fields F10 (Step S3). In Step S3, the integrated reservation server 10 searches the hotel database DB2 for hotels that match the search criteria input by the user, and generates the search result page P2.

The user terminal 30 identifies, based on a detection signal of the operation unit 34, operation performed by the user on the top page P1 (Step S4). Here, operation of selecting a hotel from the display area A20, operation of selecting the button B201, or operation of selecting the button B202 is performed. In a case in which another type of operation, such as return to the top page P1, is performed, processing corresponding to the another type of operation is executed.

When the operation of selecting a hotel from the display area A20 is executed in Step S4 (Step S4: hotel selection), processing for displaying the hotel details page P3 is executed between the integrated reservation server 10 and the user terminal 30 (Step S5). In Step S5, the integrated reservation server 10 generates the hotel details page P3 based on the hotel information stored in the hotel database DB2 that is information about the hotel selected by the user.

The user terminal 30 identifies, based on a detection signal of the operation unit 34, operation performed by the user on the hotel details page P3 (Step S6). Here, operation of selecting a plan from the display area A30, operation of selecting the button B300, or operation of selecting the button B301 is performed. In a case in which another type of operation, such as return to the search result page P2, is performed, processing corresponding to the another type of operation is executed.

When the operation of selecting a plan from the display area A30 is executed in Step S6 (Step S6: plan selection), processing for displaying the plan details page P4 is executed between the integrated reservation server 10 and the user terminal 30 (Step S7). In Step S7, the integrated reservation server 10 generates the plan details page P4 based on plan information stored in the hotel database DB2 that is information about the plan selected by the user.

The user terminal 30 identifies, based on a detection signal of the operation unit 34, operation performed by the user on the plan details page P4 (Step S8). Here, operation of selecting the button B400 or operation of selecting the button B401 is performed. In a case in which another type of operation, such as return to the hotel details page P3, is performed, processing corresponding to the another type of operation is executed.

When the operation of selecting the button B400 is executed in Step S8 (Step S8: reservation), processing for booking the hotel at a non-member price is executed between the integrated reservation server 10 and the user terminal 30 (Step S9), and the processing of FIG. 8 is ended. When the button B201 is selected in Step S4 (Step S4: reservation) and when the button B300 is selected in Step S6 (Step S6: reservation) as well, the processing of Step S9 is executed and the processing of FIG. 8 is ended.

When the operation of selecting the button B401 is executed in Step S8 (Step S8: member registration), processing for displaying the member registration page P5 is executed between the integrated reservation server 10 and the user terminal 30 (Step S10). When the button B202 is selected in Step S4 (Step S4: member registration) and when the button B301 is selected in Step S6 (Step S6: member registration) as well, the processing of Step S10 is executed and member registration to the hotel program service is started.

In Step S10, the user terminal 30 transmits the start request to the integrated reservation server 10. The integrated reservation server 10 receives the start request from the user terminal 30, and acquires the user's name and e-mail address by referring to the first user database DB1. The integrated reservation server 10 sets the acquired name and e-mail address to the fields F50A and F50B, and transmits display data of the member registration page P5 to the user terminal 30. The user terminal 30 receives this display data, and displays, on the display unit 35, the member registration page P5 on which the user's name and e-mail address registered in the integrated reservation service are automatically input to the fields F50A and F50B.

When the user inputs required information to the fields F50 and selects the button B51, the user terminal 30 transmits the registration request including the second member information input to the fields F50 to the integrated reservation server 10 (Step S11). The integrated reservation server 10 receives the registration request from the user terminal 30 (Step S12), and the processing of FIG. 8 proceeds to FIG. 9. The integrated reservation server 10 then transmits, to the hotel server 20, the registration request including the second member information received from the user terminal 30 (Step S13).

The hotel server 20 receives the registration request from the integrated reservation server 10 (Step S14), and executes processing for member registration to the hotel program service (Step S15). In Step S15, the hotel server 20 issues a new second user ID. Here, the hotel server 20 issues the e-mail address as the new second user ID. The hotel server 20 stores the issued new second user ID and the second member information received from the integrated reservation server 10 in the second user database DB3 in association with each other.

The hotel server 20 transmits the completion notification including the second user ID of the user to the integrated reservation server 10 (Step S16). The integrated reservation server 10 receives the completion notification from the hotel server 20 (Step S17), and updates the first user database DB1 so that the user is identifiable as a member of the hotel program service (Step S18). In Step S18, the integrated reservation server 10 stores the hotel program information of the user in the first user database DB1 so that the first user ID is associated with the second user ID and the second member information.

Processing for displaying the registration completion page P6 is executed between the integrated reservation server 10 and the user terminal 30 (Step S19). When the user selects the button B60, processing for returning to one of the previously displayed pages is executed between the integrated reservation server 10 and the user terminal 30 (Step S20). The processing of FIG. 9 then returns to the processing of Step S2, Step S5, or Step S7. Returning to the processing of Step S2, Step S5, or Step S7, the user is now a member of the hotel program service, and can accordingly book a plan at a members-only price. Accordingly, the processing of Step S9 is now processing for booking a hotel at a members-only price instead of a non-member price.

According to the member registration system S of the at least one embodiment, when the start request for starting member registration of the hotel program service is received, the fields F50 for member registration are displayed on one member registration page P5 in the integrated reservation service. The member registration system S requests the hotel program service server, which is associated with the hotel program service, to execute member registration based on the user's input to the one member registration page P5. This enables the user who is using the integrated reservation service to complete member registration to the hotel program service by inputting to a single page in the integrated reservation service. A burden on the user can thus be lightened when member registration to the hotel program service is executed from the integrated reservation server. Processing load on the integrated reservation server 10 in the integrated reservation service can be lightened as well because processing up through completion of the member registration to the hotel program service can be simplified. The burden on the user can be lightened also because, for example, the member registration is completed in the integrated reservation service without installing an application of the hotel program service. The burden on the user can be lightened also because, for example, the member registration is completed in the integrated reservation service without accessing a web page of the hotel program service. This benefits the hotel program service as well by facilitating bringing users who are members of the integrated reservation service into the hotel program service, and thus effectively increasing members of the hotel program service. A benefit to the integrated reservation service is that users are given incentive to use the integrated reservation service by being able to use the integrated reservation service as members of the hotel program service. For example, a user can complete member registration with a single operation instead of the two-stage operation as described in the related art. The registration required to be executed just once decreases the processing load and is accordingly beneficial to the integrated reservation server 10 and the hotel server 20 as well. This also lightens a network load by reducing the number of communication sessions over the Internet N.

The member registration system S displays, on the one member registration page P5, the fields F50 to which the second member information to be registered in the hotel program service is automatically input, based on the first member information of the user in the integrated reservation service. When a notification of completion of the member registration is received from the hotel server 20, the member registration system S displays the registration completion page P6 as a page of the integrated reservation service. The member registration system S requests the hotel server 20 to execute member registration, based on the second member information automatically input to the fields F50. This saves the user from the trouble of inputting every piece of the second member information by adopting the name, the e-mail address, and the like from the first member information as the second member information, and thus lightens the burden on the user even more. The reduction in the amount of input required for the member registration of the hotel program service also prevents the user from giving up on member registration and leaving in the middle of the process. Members of the hotel program service can effectively be increased in number as a result. In addition, a shift to a page of the hotel program service is prevented by displaying even the registration completion page P6 as a page of the integrated reservation service, and the entire process of member registration to the hotel program service from start to finish can thus be concluded as pages of the integrated reservation service.

The member registration system S displays, on the one member registration page P5, the fields F50 in which automatically input pieces of the second member information can be changed. In a case in which a piece of the second member information that has automatically been input to one of the fields F50 is changed by the user, the member registration system S requests the hotel program service system to execute member registration based on the changed piece of the second member information. This enables a user who wishes to change an automatically input piece of the second member information to change the piece of the second member information, and accordingly enhances user friendliness. For example, a case in which outdated information is registered in the integrated reservation service, and a case in which information different from information registered in the integrated reservation service is to be registered in the hotel program service can flexibly be dealt with.

The member registration system S displays, on the one member registration page P5, the fields F50A and F50B to which the second member information is automatically input and fields F50C and F50D to which the user is required to input. The member registration system S requests the hotel program service system to execute member registration, based on the second member information automatically input to the fields F50A and F50B and the input from the user to the second fields F50C and F50D. The member registration page P5 thus has a mixture of the fields F50A and F50B in which information is adopted from the first member information and the fields F50C and F50D to which the user is required to manually input, and the mixture accordingly gives flexibility to the member registration page P5. For example, instead of two-stage registration in which the user is requested to input a piece of the second member information that requires to be manually input after a piece of the second member information is registered by adopting the information from the first member information, inputting once completes member registration, and the burden on the user can accordingly be lightened. Registering once benefits the integrated reservation server 10 and the hotel server 20 as well by lightening the processing load. The network load is also lightened because the number of communication sessions over the Internet N can be decreased.

The member registration system S receives the start request issued by the user on the search result page P2, the hotel details page P3, or the plan details page P4, which includes information about a hotel found as a result of a search in the integrated reservation service. This enables the user to complete member registration to the hotel program service along a flow continued from the search of hotels affiliated with the hotel program service in the integrated reservation service, and accordingly lightens the burden on the user even more. In a case in which the member registration is completed prior to the reception of a hotel reservation request from the user, the member registration system S handles the booking of the hotel by the user as a reservation by a member of the hotel program service. This enables the user to book a hotel along a flow continued from the establishment of the user's membership of the hotel program service, and can accordingly lighten the burden on the user even more.

The member registration system S display information about a hotel in stages, and can receive the start request irrespective of what stage of the hotel program service information is to be provided. This enables the user to start the procedure of the member registration at a stage at which the user becomes interested in the membership of the hotel program service, and can accordingly lighten the burden on the user even more.

The member registration system S associates the first user ID in the integrated reservation service and the second user ID in the hotel program service with each other at the time of completion of the member registration. The member registration system S determines whether a user is a member of the hotel program service based on the association between the first user ID and the second user ID, and provides, based on the result of this determination, a plan related to the hotel program service to the user in the integrated reservation service. The member registration system S can thus provide an appropriate service in the integrated reservation service to the user who has become a member of the hotel program service. This enables the user to, for example, stay at a hotel affiliated with the hotel program service under favorable conditions and redeem reward points of the hotel program service, and accordingly enhances user-friendliness.

The member registration system S displays privileges to be given to users who become members of the hotel program service on the search result page P2, the hotel details page P3, or the plan details page P4 for receiving the start request issued by the user. This helps to generate the user's interest in the membership of the hotel program service, and can effectively increase members of the hotel program service in number.

### 5. Modification Examples

The present disclosure is not limited to the at least one embodiment described above, and can be modified suitably without departing from the spirit of the present disclosure.

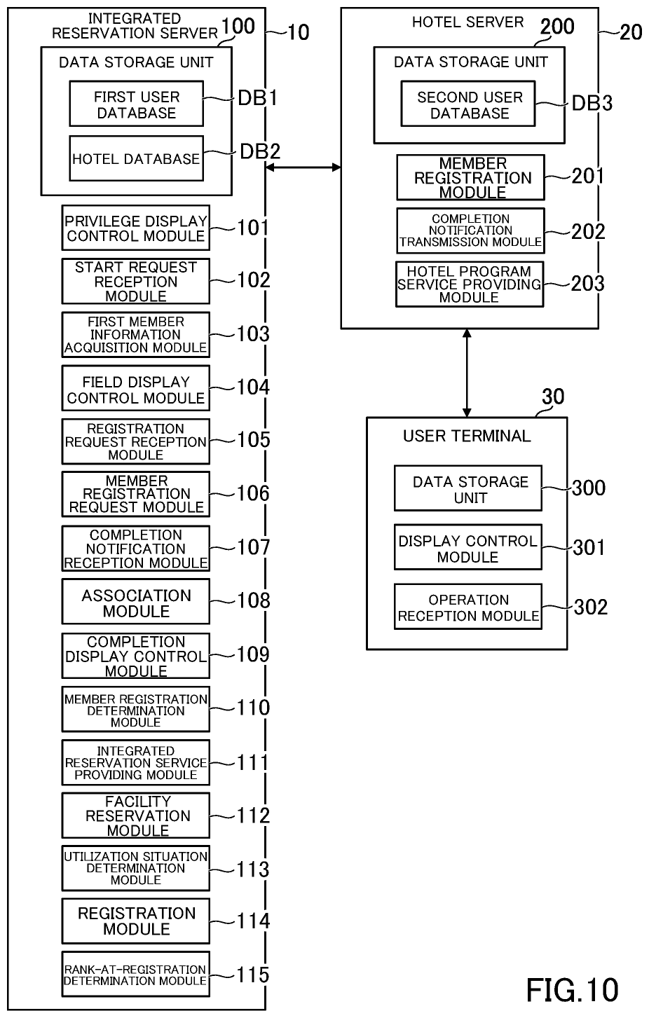

FIG. 10 is a function block diagram in modification examples. A utilization situation determination module 113, a registration module 114, and a rank-at-registration determination module 115 are implemented mainly by the control unit 11.

### 5-1. Modification Example 1

For example, the member registration system S may be designed so that member registration to a plurality of hotel program services is executable from the integrated reservation service. In Modification Example 1, member registration of “CCC Group” and “DDD group” which provide other hotel program services is executable other than the member registration of “BBB Group” described in the at least one embodiment. Accordingly, in Modification Example 1, member registration of three hotel program services is executable from the integrated reservation service. A user can become a member of any hotel program service out of the three hotel program services. The number of hotel program services to which users can be registered as members from the integrated reservation service can be any number, and is not limited to three. Information indicating which hotel is affiliated with which hotel program service is stored in the hotel database DB2.

In Modification Example 1, a plurality of items related to the first member information are registered in the integrated reservation service as in the at least one embodiment. In the case of the first user database DB1 of FIG. 5, eight items which are the first password, a name, an e-mail address, gender, a birth date, an age, an address, and a phone number are registered. As described in the at least one embodiment, the items can be of any type, and are not limited to those examples.

In Modification Example 1, items of the second member information required for member registration are set down for each of the hotel program services. The member registration system S described in the at least one embodiment is not a dedicated system for a specific hotel, and may have a function as a platform. A database in which items of information required for member registration are set is prepared for each hotel that has a hotel program service. For example, the integrated reservation service provides, on this platform, a member registration service for a plurality of hotel program services including “BBB Group,” “CCC Group,” and “DDD Group.”

For example, “CCC Group” and “DDD Group” may require second member information different from the second member information required for member registration of “BBB Group,” which is a name, an e-mail address, and whether to receive distribution of an e-mail magazine. In Modification Example 1, pieces of the second member information that vary depending on which hotel program service offers membership desired by the user to join are automatically input to the fields F50. The member registration page P5 includes the fields F50 suited to the hotel program service.

Data indicating a relationship between a hotel program service and items of the first member information that are adoptable as the second member information is stored in the data storage unit 100. The first member information acquisition module 103 acquires items determined by a hotel program service of interest out of a plurality of items. The first member information acquisition module 103 acquires the same items as items of the second member information to be registered in a hotel program service for which the user has issued the start request out of the plurality of hotel program services.

An example in which a name, an e-mail address, an address, and a phone number, four items in total, are required for member registration of “CCC Group” is discussed. When the user issues the start request to start member registration of “CCC Group,” the first member information acquisition module 103 refers to the first user database DB1 to acquire those four items. An example in which a name, an e-mail address, and a birth date, three items in total, are required for member registration of “DDD Group” is discussed. When the user issues the start request to start member registration of “DDD Group,” the first member information acquisition module 103 refers to the first user database DB1 to acquire those three items.

The field display control module 104 displays, on the one member registration page P5, the fields F50 to which the second member information is automatically input based on items determined by the hotel program service. Modification Example 1 differs from the at least one embodiment in that types of the first member information that are determined by which hotel program service offers membership desired by the user to join are automatically input to the fields F50 as the second member information of this hotel program service. However, processing itself for displaying the one member registration page P5 on which the second member information is automatically input to the fields F50 is as described in the at least one embodiment.

According to Modification Example 1, the member registration system S acquires items determined by a hotel program service of interest, out of a plurality of items related to the first member information. The member registration system S displays, on the one member registration page P5, the fields F50 to which the second member information is automatically input based on the items determined by the hotel program service. This accomplishes automatic input suited to a hotel program service that offers membership desired by the user to join, and can accordingly lighten the burden on the user in a case in which member registration of a plurality of hotel program services is executable.

### 5-2. Modification Example 2

For example, a plurality of pieces of the first member information that are of the same type are registered in the integrated reservation service in some cases. When an address qualifies as a piece of the first member information, the user may register three addresses that are addresses of the user's home, the home of the user's parents, and a workplace in the integrated reservation service. When an e-mail address qualifies as a piece of the first member information, the user may register three e-mail addresses that are e-mail addresses of a smart phone, free e-mail software, and a workplace in the integrated reservation service. In this case, the user may be allowed to select information to be adopted as a piece of the second member information. Further, when one of the plurality of pieces of the first member information is set as a default value, the piece of the first member information that is set as a default value may automatically be selected. The member registration system S may also be designed so that a piece of the first member information other than the piece of the first member information that is set as a default value is selectable.

The first member information acquisition module 103 in Modification Example 2 acquires a plurality of pieces of the first member information. Modification Example 2 differs from the at least one embodiment in that a plurality of pieces of the first member information are acquired. However, the method itself of acquiring the first member information is as described in the at least one embodiment. In a case of a user who has not registered a plurality of pieces of the first member information in the integrated reservation service, it suffices that one piece of the first member information is acquired as in the at least one embodiment.

The field display control module 104 displays, on the one member registration page P5, the fields F50 in each of which one of the plurality of pieces of the first member information is selectable as a piece of the second member information. The fields F50 having a pulldown menu format are taken here as an example. However, fields having other formats such as checkboxes or radio buttons may be used to select the first member information to be adopted as the second member information.

The member registration request module 106 requests the hotel server 20 to execute member registration, based on results of the selection in the fields F50. Modification Example 2 differs from the at least one embodiment in that the second member information selected from the fields F50 is registered in the hotel program service. However, member registration is requested by following the same flow as the flow in the at least one embodiment. The first member information selected by the user from the fields F50 to be adopted as the second member information may be changed by input from the user.

According to Modification Example 2, the member registration system S displays, on the one member registration page P5, the fields F50 in each of which one of a plurality of pieces of the first member information is selectable as a piece of the second member information. The member registration system S requests the hotel program service system to execute member registration, based on results of the selection in the fields F50. This enables the user to select information to be adopted as the second member information from a plurality of pieces of the first member information, and accordingly enhances user-friendliness as well as lightening the burden on the user.

### 5-3. Modification Example 3

For example, the field display control module 104 may display the one member registration page P5 in a display mode suited to each hotel program service. The display mode is an appearance of the one member registration page P5. For example, an overall layout, each individual image, a background, a description, a color of text, or a font of text qualifies as the display mode. Data indicating a relationship between a hotel program service and a display mode of the member registration page P5 is stored in the data storage unit 100.

For example, the field display control module 104 displays the member registration page P5 of “BBB Group” so that a logo of “BBB Group” is included. An overall tone in addition to the logo may take after a page of the hotel program service provided by “BBB Group.” In a case in which “BBB Group” uses a specific color such as blue or red as a corporate color, the field display control module 104 displays the member registration page P5 in the specific color. When member registration is executable for other hotel program services of “CCC group,” “DDD group,” and the like as in Modification Example 1, the field display control module 104 displays the member registration page P5 of each one of the other hotel program services in a display mode suited to the other hotel program service.

According to Modification Example 3, the member registration system S displays the one member registration page P5 in a display mode suited to each hotel program service. This helps the user to know to which hotel program service the user is about to register as a member, and accordingly enhances user-friendliness.

### 5-4. Modification Example 4

For example, the function of executing member registration of the hotel program service from the integrated reservation service may be provided only to users who use the integrated reservation service often. In Modification Example 4, a rank of a user is determined in the integrated reservation service. The user is ranked higher as the user uses the integrated reservation service more. In a case in which the integrated reservation service is in cooperation with another service such as an electronic commerce transaction service or a financial service, the user is ranked higher as the user uses the another service. For a mechanism of the ranking itself, various publicly-known ranking mechanisms are usable. It suffices that the rank changes in accordance with a predetermined condition.

The member registration system S further includes the utilization situation determination module 113 for determining whether a utilization situation of the user in the integrated reservation service is a predetermined situation. The rank is an example of the utilization situation. Accordingly, a description of the rank can be read as a description of the utilization situation. The utilization situation can be any type of information and is not limited to the rank. For example, the user's amount of use, number of times of use, frequency of use, and period of use may each qualify as the utilization situation, or combinations of some of those, or a combination of all of those including the rank may qualify as the utilization situation. Further, the utilization situation may include a utilization situation in another service that is in cooperation with the integrated reservation service, in addition to the utilization situation in the integrated reservation service. The predetermined situation is a situation that serves as a criterion for determination about whether to provide the member registration function. For example, when there are five ranks of the integrated reservation service and the member registration function is to be provided to users of the third rank or higher, the third rank is the predetermined situation.

The field display control module 104 controls whether to display the one member registration page P5 based on a result of the determination of the utilization situation determination module 113. For example, the field display control module 104 does not display the one member registration page P5 when it is not determined that the utilization situation of the user is the predetermined situation, and displays the one member registration page P5 when it is determined that the utilization situation of the user is the predetermined situation. In this case, the member registration function is provided to users of a predetermined rank or higher.

According to Modification Example 4, the member registration system S determines whether the utilization situation of a user in the integrated reservation service is a predetermined situation and, based on the result of the determination, controls whether to display the one member registration page P5. The member registration function can thus be provided as a privilege to, for example, users who use the integrated reservation service often.

The field display control module 104 may perform control in a manner opposite to the example given above, by not displaying the one member registration page P5 when it is determined that the utilization situation of the user is a predetermined situation and displaying the one member registration page P5 when it is not determined that the utilization situation of the user is the predetermined state. In this case, the member registration function is provided to users lower than a predetermined rank. This gives a user who uses the integrated reservation service infrequently an incentive to use the integrated reservation service on a continuous basis, by providing the member registration function convenient to users.

### 5-5. Modification Example 5

For example, the member registration system S may further include the registration module 114 for registering, in the integrated reservation service, the second member information to be registered in the hotel program service, based on the user's input to the one member registration page P5. In Modification Example 5, a case of storing the second member information as part of the hotel program information stored in the first user database DB1 is described. However, the second member information may be stored as information separate from the hotel program information. The registration module 114 stores, as part of the hotel program information, the second member information registered in the second user database DB3 in association with the second user ID, at the time when a notification of registration completion is received from the hotel server 20, or the time when the registration request is received from the user terminal 30.

The integrated reservation service providing module 111 provides the integrated reservation service based on the second member information registered in the integrated reservation service. For example, when the user books a hotel affiliated with the hotel program service, the integrated reservation service providing module 111 may automatically input the second member information stored in the first user database DB1 to a field on a screen for inputting information about a lodger. To give another example, the integrated reservation service providing module 111 may enable the user to use, from the integrated reservation service, the same level of service as when the user uses the hotel program service by logging in to the hotel program service.

According to Modification Example 5, the member registration system S provides the integrated reservation service based on the second member information registered in the integrated reservation service. This enables the user to use, from the integrated reservation service, the same level of service as when, for example, the user uses the hotel program service by logging in to the hotel program service, and thus enhances user-friendliness.

### 5-6. Modification Example 6

For example, the hotel program service may be usable at a first price. When a user becomes a member of the hotel program service, for example, the user logs in directly to the hotel program service, and can book a hotel affiliated with the hotel program service. The first price is a price for this case. The first price is a price for hotel reservation directly from the hotel program service instead of from the integrated reservation service. In the integrated reservation service, a hotel can be used at a second price higher than the first price. The second price is the non-member price described in the at least one embodiment.

The integrated reservation service providing module 111 in Modification Example 6 provides the integrated reservation service at the second price to the user when the user is not determined to be a member of the hotel program service, and provides the integrated reservation service at the first price to the user when the user is determined to be a member of the hotel program service. In Modification Example 6, members-only price information in the hotel database DB2 is set so that the members-only price is equal to the first price. The integrated reservation service providing module 111 accordingly provides the integrated reservation service so that, after the user becomes a member of the hotel program service, a reservation can be made at the same price as when the user makes a reservation directly from the hotel program service. For example, the integrated reservation service providing module 111 displays the same price as the first price on the search result page P2, the hotel details page P3, or the plan details page P4.

According to Modification Example 6, the member registration system S provides the integrated reservation service at the second price to the user when the user is not determined to be a member of the hotel program service, and provides the integrated reservation service at the first price to the user when the user is determined to be a member of the hotel program service. This enables the user to book a hotel from the integrated reservation service at the same price as when the user uses the hotel program service by logging in to the hotel program service, and accordingly enhances user-friendliness.

### 5-7. Modification Example 7

For example, the integrated reservation service providing module 111 may provide the integrated reservation service to the user based on the user's utilization situation in the integrated reservation service and the user's utilization situation in the hotel program service. A description given here takes ranks as an example of the utilization situation as in Modification Example 4. However, the utilization situation may be other types of information described in Modification Example 4. In Modification Example 7, a rank unique to the hotel program service is used as well. For a mechanism itself of the ranking in the hotel program service, various publicly-known ranking mechanisms are usable. It suffices that the rank changes in accordance with a predetermined condition.

The integrated reservation service providing module 111 provides the integrated reservation service to the user by considering the user's rank in the integrated reservation service and the user's rank in the hotel program service in a comprehensive manner. For example, the integrated reservation service providing module 111 provides the integrated reservation service so that the user can use the integrated reservation service under more favorable conditions when the user is ranked higher in the integrated reservation service and is ranked higher in the hotel program service. A favorable condition is an inexpensive price, having a choice to check in early, having a choice to stay long, having a choice to check out late, or many usable facilities. It is sufficient for the favorable conditions to be conditions suitable for the second service.

According to Modification Example 7, the member registration system S provides the integrated reservation service to the user based on the user's utilization situation in the integrated reservation service and the user's utilization situation in the hotel program service. The user can thus use the integrated reservation service that is provided by taking into consideration not only the user's utilization situation in the integrated reservation service but also the user's utilization situation in the hotel program service, and user-friendliness is accordingly enhanced. For example, when the user books a hotel affiliated with the hotel program service from the integrated reservation service, the user is ranked higher in both of the services, and is accordingly given an incentive to use both of the services.

### 5-8. Modification Example 8

For example, when the user becomes a member of the hotel program service from the integrated reservation service, the integrated reservation service providing module 111 may provide the integrated reservation service to the user under a condition more favorable than when the user becomes a member of the hotel program service from the hotel program service. The meaning of a favorable condition is as described in Modification Example 7. For example, the integrated reservation service providing module 111 applies a special new-member discount when the user becomes a member of the hotel program service from the integrated reservation service. A price to which the new-member discount is applied is lower than when the user registers as a member from the hotel program service and books a hotel directly from the hotel program service. The integrated reservation service providing module 111 provides the user with the integrated reservation service so as to be more inexpensive than when a reservation is made directly from the hotel program service.

According to Modification Example 8, when the user becomes a member of the hotel program service from the integrated reservation service, the member registration system S provides the integrated reservation service to the user under a more favorable condition than when the user becomes a member of the hotel program service from the hotel program service. This gives the user an incentive to register as a member of the hotel program service from the integrated reservation service.

### 5-9. Modification Example 9

For example, the member registration system S may further include the rank-at-registration determination module 115 for determining the user's rank at the time of member registration to the hotel program service, based on the user's utilization situation in the integrated reservation service. In Modification Example 9, a rank based on the utilization situation of the user is set in the hotel program service as in Modification Example 7. The rank-at-registration determination module 115 determines the user's rank at the time of member registration so that the user is ranked higher in the hotel program service when the user has a higher rank in the integrated reservation service. The user's rank at the time of member registration is an initial rank in the hotel program service. According to Modification Example 9, the member registration system S sets ranks based on the user's utilization situations, and determines the user's rank at the time of member registration to the hotel program service based on the utilization situation of the user in the integrated reservation service. This enables a user who uses the integrated reservation service often to use the hotel program service in a favorable manner, and accordingly enhances user-friendliness.

### 5-10. Other Modification Examples

For example, the modification examples described above may be combined with one other.

For example, the second member information is not required to be automatically input to the fields F50 on the member registration page P5. Even when the second member information is not automatically input, member registration of the hotel program service is completed from the integrated reservation service, without requiring two-stage operation as in the related art, and the burden on the user can thus be lightened. For example, the member registration system S may be designed so that a user who becomes a member of the hotel program service cannot stay at a hotel at a members-only price through the integrated reservation service. In this case, the user may be enabled to use the hotel program service by notifying, when the user books a hotel from the integrated reservation service, the hotel that the user is a member, and rewarding the user with reward points of the hotel program service. For example, the second member information input by the user to the member registration page P5 may be transmitted directly to the hotel server 20 from the user terminal 30. For example, when the user cancels the membership of the hotel program service, association between the first user ID and the second user ID may be dissolved.

For example, the member registration system S may be designed so that, when the user is a member of the hotel program service, the first user ID in the integrated reservation service and the second user ID in the hotel program service can be associated with each other. In this case, the processing described in the at least one embodiment is not required to be executed by the member registration system S. For example, the user may be allowed to input the user's own second user ID on the member registration page P5. In this case, the member registration page P5 may display both of a field used by the user to newly become a member and a field used by the user who is already a member to input the second user ID. When the user who is already a member associates the first user ID and the second user ID, a special privilege may be given. As an example of the special privilege, the user may be allowed to book a hotel at a special price from the integrated reservation service.

For example, the combination of the first service and the second service can be any combination, and is not limited to the example of the at least one embodiment. To give an example, the first service and the second service may be an electronic commerce transaction service and a reward point service, respectively. In this case, the user can complete member registration of the reward point service along a flow of searching for a commercial product in the electronic commerce transaction service. After the user becomes a member of the reward point service, reward points provided by the reward point service may be earned when the commercial product found through the search is purchased. To give another example, the first service and the second service may be a hotel program service and an integrated reservation service, respectively. That is, the first service and the second service may have a relationship reversed from the relationship in the at least one embodiment. In this case, the user can execute member registration of the integrated reservation service from the hotel program service. The relationship between the first service and the second service can be any other combination.

For example, although a case in which main functions are implemented by the integrated reservation server 10 is described, the functions may be divided among a plurality of computers. For example, the functions may be divided among the integrated reservation server 10, the hotel server 20, and the user terminal 30. For example, the data stored on the integrated reservation server 10 or the hotel server 20 in the description given above may be stored on other database servers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A member registration system which is configured to:
receive a start request issued by a user in a first service to start member registration of a second service;
display, when the start request is received, fields for the member registration on one page in the first service; and
request, based on input to the one page from the user, a second service server associated with the second service to execute the member registration.

2. The member registration system according to claim 1,
wherein the member registration system is configured to:
acquire first member information of the user in the first service;
display, based on the first member information, on the one page, the fields to which second member information to be registered in the second service is automatically input; and
issue a request to the second service server to execute the member registration, based on the second member information automatically input to the fields,
wherein the second service server is configured to execute the member registration of the second service based on the request issued by the member registration system, and transmit a completion notification indicating completion of the member registration of the second service to the member registration system, and
wherein the member registration system is configured to:
receive the completion notification from the second service server; and
display, when the completion notification is received, a registration completion page indicating completion of the member registration as a page in the first service.

3. The member registration system according to claim 2, wherein the member registration system is configured to:
display, on the one page, the fields in which the automatically input second member information are changeable; and
issue, when the user changes the second member information automatically input to the fields, a request to the second service server to execute the member registration, based on the changed second member information.

4. The member registration system according to claim 2, wherein the member registration system is configured to:
display, on the one page, a first field to which the second member information is automatically input, and a second field to which input by the user is required; and
issue a request to the second service server to execute the member registration, based on the second member information automatically input to the first field and the input by the user to the second field.

5. The member registration system according to claim 2,
wherein, in the first service, a plurality of items related to the first member information are registered, and
wherein the member registration system is configured to:
acquire items depending on the second service out of the plurality of items; and
display, on the one page, the fields to which the second member information is automatically input, based on the items depending on the second service.

6. The member registration system according to claim 2,
wherein, in the first service, a plurality of pieces of the first member information of the same type are registered, and
wherein the member registration system is configured to:
acquire the plurality of pieces of the first member information;
display, on the one page, the fields in which one of the plurality of pieces of the first member information is selectable as the second member information; and
request the second service server to execute the member registration, based on a result of the selection in the fields.

7. The member registration system according to claim 1, wherein the member registration system is configured to display the one page in a display mode suited to the second service.

8. The member registration system according to claim 1, wherein the member registration system is configured to:
determine whether a utilization situation of the user in the first service is a predetermined situation; and
control whether to display the one page based on a result of the determination.

9. The member registration system according to claim 1,
wherein, in the first service, an item matching a search criterion specified by the user is searched for from among a plurality of items including a second service item related to the second service, and
wherein the member registration system is configured to receive the start request issued by the user on a second service item page including the second service item searched for in the first service.

10. The member registration system according to claim 1,
wherein, in the first service, a reservation for a facility related to the second service is received, and
wherein the member registration system is configured to:
execute a reservation made by the user for the facility; and
execute, when the member registration is completed prior to the reception of the reservation made by the user for the facility, the reservation made by the user for the facility, with the user treated as a member of the second service.

11. The member registration system according to claim 1,
wherein, in the first service, second service information about the second service is providable to the user in stages, and
wherein the member registration system is configured to receive the start request irrespective of what stage of the second service information is to be provided.

12. The member registration system according to claim 1, wherein the member registration system is configured to:
associate, when the member registration is completed, first user identification information of the user in the first service and second user identification information of the user in the second service with each other;
determine whether the user is a member of the second service based on the association between the first user identification information and the second user identification information; and
provide, based on a result of the determination, a second service item related to the second service to the user in the first service.

13. The member registration system according to claim 12, wherein the member registration system is configured to:
provide, when the user is determined to be a member of the second service, the first service to the user so that a predetermined privilege is given to the user; and
display, on a page for receiving the start request issued by the user, privilege information about the predetermined privilege to be given when the user becomes a member of the second service.

14. The member registration system according to claim 12, wherein the member registration system is configured to:
register, in the first service, based on the input to the one page from the user, second member information to be registered in the second service; and
provide the first service based on the second member information registered in the first service.

15. The member registration system according to claim 12,
wherein the second service is available for use at a first price,
wherein the first service is available for use at a second price higher than the first price, and
wherein the member registration system is configured to provide the first service to the user at the second price when the user is determined to be a non-member of the second service, and provide the first service to the user at the first price when the user is determined to be a member of the second service.

16. The member registration system according to claim 12, wherein the member registration system is configured to provide the first service to the user based on a utilization situation of the user in the first service and a utilization situation of the user in the second service.

17. The member registration system according to claim 12, wherein the member registration system is configured to provide, when the user becomes a member of the second service through the first service, the first service to the user under a condition more favorable than when the user becomes a member of the second service through the second service.

18. The member registration system according to claim 1,
wherein, in the second service, a rank based on a utilization situation of the user is set, and
wherein the member registration system is configured to determine a rank of the user at a time of member registration of the second service, based on a utilization situation of the user in the first service.

19. A member registration method, comprising:
receiving a start request issued by a user in a first service to start member registration of a second service;
displaying, when the start request is received, fields for the member registration on one page in the first service; and
requesting, based on input to the one page from the user, a second service server associated with the second service to execute the member registration.

20. A non-transitory information storage medium having stored thereon a program for causing a computer to:
receive a start request issued by a user in a first service to start member registration of a second service;
display, when the start request is received, fields for the member registration on one page in the first service; and
request, based on input to the one page from the user, a second service server associated with the second service to execute the member registration.
